(19) United States
(12) Patent Application Publication
(10) Pub. No.: US 2019/0084182 A1
(43) Pub. Date: Mar. 21, 2019

(54) SOLVENT-BORNE WOOD PRESERVATIVE COMPOSITIONS

(71) Applicant: Koppers Performance Chemicals Inc., Pittsburgh, PA (US)

(72) Inventors: Jun Zhang, Peachtree City, GA (US); Md S. Islam, Griffin, GA (US)

(21) Appl. No.: 15/933,047

(22) Filed: Mar. 22, 2018

Related U.S. Application Data
(60) Provisional application No. 62/476,067, filed on Mar. 24, 2017.

(51) Int. Cl. B27K 3/34; B27K 3/50; A01N 43/56; A01N 43/653; A01N 25/04

(52) U.S. Cl. CPC B27K 3/343; B27K 3/50; A01N 25/04; A01N 43/653; A01N 43/56

(57) ABSTRACT

Wood preservative compositions comprising a particulate copper compound in a solvent carrier with low aromatic content. Particulate copper dispersions in this composition demonstrated superior stability, and wood treated with the composition is protected from attack by wood decay fungi and termites. The invention is also directed to wood preservative compositions comprising: (a.) a biodegradable organic solvent carrier selected from the group consisting of vegetable oil, renewable resource oil, and biodiesel; (b.) a dispersion of solid particles of a metal compound having a particle size between about 0.005 microns to about 10 microns; (c.) an organic biocide; and (d.) a dispersant; ratio of the dispersant to the metal compound is from about 1:500 to about 100:1 (wt/wt). The invention is also directed to compositions comprising penflufen and solvent carriers. The invention is also directed to methods of treating wood using the compositions, and wood treated with the disclosed compositions and methods.

The instant application claims priority to U.S. Provisional Application Ser. No. 62/476,067 filed Mar. 24, 2017, which is hereby incorporated by reference in its entirety. All patents, printed publications, and references cited herein are hereby incorporated by reference in their entireties.

### FIELD OF THE INVENTION

The invention pertains to wood preservative compositions and methods of using the compositions for protecting wood and wood-based products from biological attacks by wood decay fungi, insects and termites.

### BACKGROUND

Wood preserving compositions are used to protect wood and other cellulose-based materials, such as paper, particleboard, textiles, rope, etc., from attack by wood-destroying organisms, such as, for example, fungi and insects. Conventional wood preserving compositions often contain metal compounds, organic biocides, or both in a solvent carrier. Some examples of metal compounds used in wood preservation formulations are compounds of copper, zinc, tin, boron, fluoride. Some examples of organic biocides that have been used in wood preservation formulations include insecticides, fungicides, moldicides, algaecides, bactericides, which have been dissolved in an oil-borne carrier directly. Examples of such compounds are azoles, carbamates, isothiazolinones, thiocyanates, sulfenamides, quaternary phosphonium compounds, quaternary ammonium compounds, nitriles, pyridines, etc. and synergistic mixtures of these compounds.

The preparation of such metal and organic compounds together in organic solvent carriers is desirable because the organic solvent carrier may impart water repellency and dimensional stability to cellulosic substrates such as wood and does not cause swelling of the treated wood or timber. However, despite the efforts of many inventors, it has been difficult or impossible to produce organic carrier preservative/biocide systems which contain a solid dispersion of particles. Heretofore, metal compounds have been added to organic carriers as soluble metal complexes, or the metal compounds are dissolved in organic carriers to enhance their treating characteristics in the organic solvent. For example, copper naphthenate (CuN), a common solvent-borne copper based preservative, is a solution of cupric ion complexed with naphthenic acids and solubilized in hydrocarbon solvents. Another example is oxine copper wood preservative. Oxine copper is a copper 8-quinolinate (Cu8) complex dissolved in hydrocarbon solvents. CuN and Cu8 wood preservatives are both listed in the 2016 American Wood Protection Association (AWPA) Book of Standards as P36-16 and P37-11, respectively.

Another technique for adding metal compounds to organic carriers is to form a water-in-oil emulsion in which the metal compounds are dissolved in water as metal complexes, and the aqueous metal complexes are then mixed with emulsifying compounds to produce a water-in-oil emulsion. However, there have been stability and compatibility problems using these water-in-oil emulsions during wood vacuum pressure treatment because of the sensitivity of the emulsion under high shear mixing or when the formulation is transferred from the storage tank to the treating cylinder.

As a result, there remains an unmet need to produce a stable wood preservative composition containing metal compounds in organic solvent carriers. Accordingly, it is one of the objects of the present invention to meet this need by using a composition of dispersed particulate metal compounds, especially copper compounds, in a solvent carrier. Particulate copper compounds, such as basic copper carbonate, when present in an aqueous medium, are an effective fungicide against decay fungi and termites because they can release cupric ions in water solution.

When a particulate copper compound is used in an organic solvent carrier, its ability to release ionic copper, and its efficacy against decay fungi is unknown. We have surprisingly discovered that particulate copper in organic solvent carrier is also efficacious against wood decay fungi.

Wood preservative formulations are generally prepared using water as the carrier. However, organic solvent carriers are also used in many preservative systems, such as Light Organic Solvent Preservative (LOSPs) treatments, creosote treatments, pentachlorophenol (PCP) treatments or copper naphthenate (CuN) treatments. The 2016 American Wood Protection Association (AWPA) Book of Standards lists several standardized organic solvent systems, such HAS-14, HSC-11, HSF-11, HSG-11, and HSH-14 for use as carriers for wood preservatives.

The majority of these solvents, such as the LOSP solvent or PCP/Cu-Nap/Creosote solvents have a strong odor due to the presence of aromatic compounds. The presence of aromatic compounds can not only emit strong odor but this also causes concerns with respect to worker exposure. As result, it is another object of this invention to overcome the odor and health concerns associated with organic solvents, by using alternative organic solvent carriers in wood preservative formulations. In addition, we have unexpectedly found that using organic solvents containing low or essentially no aromatic content to make particulate copper formulations of the invention can enhance the particle size and dispersion stability of the formulations.

Another problem frequently encountered when treating wood with wood preservative formulations comprising particulate compounds in organic carriers is referred to as “failure” or “fallout.” Many times, wood treated with these formulations will have a left-over residue on the surface of the wood. The residue is due to agglomeration/aggregation of the particulate compound and can be visible on the surface of the treated wood. The residue is formed by filtering of the particulate compound on the wood, which results from agglomeration of the particulate compounds. The failure and fallout phenomena are disadvantageous because agglomeration prevents the particulate compound from effectively penetrating into the wood. Surface deposits such as left-over residue are also harmful to the environment because the treated wood, when placed into service, loses the residue to the surrounding ground or water. This loss of material results in reduced resistance to fungal decay and insect attack. The inventors of the present invention have surprisingly discovered that organic carriers having low aromatic content, in combination with certain specific particulate copper compounds and dispersants, are effective wood preservation formulations for treating wood and will not lead to the failure or fallout phenomenon.

The present invention relates to stable wood preservative compositions comprising particulate copper compounds in an organic solvent carrier with low aromatic content. The particulate copper compositions of the invention have been surprisingly discovered to be efficacious against decay fungi. In addition, the compositions of the invention have low aromatic content and low odor. Furthermore, a surprising aspect of the compositions of the invention is that the particulate copper particles have superior stability in the low aromatic content organic solvent carriers. This superior stability facilitates pressure impregnation of wood using the wood preservative compositions of the invention.

### SUMMARY OF THE INVENTION

The present invention provides compositions and methods for preservation of wood. The compositions comprise a particulate metal compound, an organic solvent carrier with little or no aromatic content, and a dispersant. It has been surprisingly found that the particulate metal compound is efficacious against wood decay fungi. In addition, the particulate dispersion formulations have excellent shelf life stability. The solvents with low aromatic content disclosed in the current invention generally refer to any hydrocarbon solvents with aromatic content less than 22% v/v, or preferably less than 8% v/v, less than 5% v/v, less than 1% v/v, less than 0.1% v/v or essentially 0.0% v/v.

In certain embodiments, the invention is directed to methods of treating wood or a wood product comprising a step of contacting the wood or wood product with the particulate metal wood preservative composition in a low aromatics solvent.

In another embodiment, the particulate preservative composition may further contain an organic biocide, such as triazole fungicides or pyrazole fungicides. The ratio of particulate metal to organic biocide varies from about 1:1 to about 500:1.

In certain embodiments, the metal compound in the present composition is a micronized copper compound, a solvent with low aromatic content, and a dispersant. The micronized copper composition may further comprise a triazole compound. Triazoles of the micronized copper composition of the present invention include, but are not limited to azaconazole; bromuconazole; cyproconazole; diclobutrazol; difenoconazole; diniconazole; diniconazole-M; epoxiconazole; etaconazole; fenbuconazole; fluquinconazole; flusilazole; flutriafol; furconazole; furconazole-cis; hexaconazole; imibenconazole; ipconazole; ipfentrifluconazole; mefentrifluconazole; metconazole; myclobutanil; penconazole; propiconazole; prothioconazole; quinconazole; simeconazole; tebuconazole; tetraconazole;

triadimefon; triadimenol; triticonazole; uniconazole; uniconazole-P.

In certain embodiments the wood preservative composition of the invention comprises, a metal compound which is a micronized copper compound, a solvent with low aromatic content, and a dispersant. The micronized copper composition may further comprise a pyrazole fungicide. Examples of pyrazoles include, but are not limited to benzovindiflupyr; bixafen; fenpyrazamine; fluxapyroxad; furametpyr; isopyrazam; oxathiapiprolin; penflufen; penthiopyrad; pydiflumetofen; pyraclostrobin; pyrametostrobin; pyraoxystrobin; rabenzazole; sedaxane.

In certain embodiments, the wood preservative composition of the invention comprises: (a.) a biodegradable organic solvent carrier selected from the group consisting of vegetable oil, renewable resource oil, and biodiesel; (b.) a dispersion of solid particles of a metal compound having a particle size between about 0.005 microns to about 10 microns; (c.) an organic biocide; and (d.) a dispersant; wherein the ratio of the dispersant to the metal compound is from about 1:500 to about 100:1 (wt/wt).

In certain embodiments, the wood preservative of the invention comprises an organic solvent that is a vegetable oil selected from the group consisting of linseed oil, coconut oil, corn oil, cottonseed oil, olive oil, palm oil, canola oil, palm kernel oil, peanut oil, rapeseed oil, safflower oil, sesame oil, soybean oil, sunflower oil, castor oil, tung oil, poppyseed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

In certain embodiments, the wood preservative composition comprises an organic solvent that is a renewable resource oil and/or biodiesel selected from the group consisting of tall oil, vegetable oil- and animal fat-based diesel fuel, wherein said diesel fuel is comprised of long-chain alkyl (methyl, ethyl, or propyl) esters.

In certain embodiments, the invention is directed to methods of treating wood using the compositions disclosed herein, and to wood that has been treating using such compositions and methods. In certain embodiments, the compositions of the present invention can be impregnated into cellulosic materials, such as wood by standard methods, such as vacuum and/or pressure methods. When such a composition is used for preservation of wood, there is minimal leaching of the metal component upon exposure of the wood to the elements during use. For use in preserving wood and other cellulose-based materials, the metal compounds have a particle size between about 0.005 microns to about 25.0 microns.

In certain embodiments, the invention is directed to wood preservative compositions comprising: (a.) a biodegradable organic solvent carrier selected from the group consisting of vegetable oil, renewable resource oil, and biodiesel; (b.) an amount of penflufen effective to render wood treated with said composition resistant to fungal decay.

In certain embodiments, the invention is directed to methods of treating a wood product to render it resistant to fungal decay and dimensionally stable, said method comprising the steps of 1) contacting said wood with a composition comprising: (a) an organic solvent carrier having low aromatic content; and (b) penflufen; and 2) drying said wood product, wherein the treated wood product is rendered resistant to fungal decay and dimensionally stable.

In certain embodiments, the invention is directed to methods of treating a wood product to render it resistant to fungal decay and dimensionally stable, said method comprising the steps of 1) contacting said wood with a composition comprising: (a) biodegradable organic solvent carrier selected from the group consisting of vegetable oil, renewable resource oil, and biodiesel; and (b) an effective amount of penflufen to render said wood resistant to fungal decay; and 2) drying said wood product, wherein the treated wood product is rendered resistant to fungal decay and dimensionally stable.

The compositions of the present invention can be vacuum and/or pressure impregnated into cellulosic materials such as wood by standard methods to effectively preserve the material from fungal decay and insect attack.

### DETAILED DESCRIPTION OF THE INVENTION

Disclosed herein is a wood preservative composition for protecting cellulosic material, more particularly wood. The composition comprises a metal compound, a hydrocarbon solvent with low aromatics, and a dispersant. The composition imparts to the treated wood resistance to wood decay fungi, insects, and termites. The metal compound can be selected from compounds/complexes of copper, zinc, iron, or silver, and the preferred metal compound is a copper compound.

### Copper Compounds

Generally, the copper or copper compounds of the present invention are prepared from, but are not limited to, copper metal, cuprous oxide (a source of copper(I) ions), cupric oxide (a source of copper(II) ions), copper hydroxide, copper carbonate, basic copper carbonate, copper oxychloride, copper 8-hydroxyquinolate, copper dimethyldithiocarbamate, copper omadine, copper borate or basic copper borates, copper residues (copper metal byproducts) or any suitable copper source.

The wood preservative compositions of the invention comprise copper compounds in the form of a particulate dispersion. The particulate copper has a particle size of about 0.005 microns to about 25 microns. The preferred particle size is in the range of about 0.05 microns to about 5 microns, and the most preferred particle size is in the range of about 0.1 microns to about 1.0 microns. The average or mean particle size can be in the range of about 0.05 microns to about 1.0 microns, and the preferred mean particle size is about 0.08 microns to about 0.5 microns, and the most preferred particle size about 0.1 microns to about 0.4 microns.

### Milling and Milling Media

The particulate copper compounds suitable for wood treatment can be prepared through wet ball milling with grinding media of specified characteristics. The grinding media are ceramic materials, such as zirconium oxide, zirconia, yttrium or magnesium stabilized zirconia or any other type of ceramic materials having a density greater than 3 grams/cm³, for example equal to or greater than 3.8 grams/cm³, preferably greater than 5.5, grams/cm3. The particle size of the grinding media can vary from 50 microns to 1000 microns with a preferred size of 200 to 400 microns. Additionally, regardless of the particle size of the feedstock, the particles can be broken down to injectable size in a matter of minutes to at most a few hours. Beneficially, all injectable formulations for wood treatment should be wet-milled, even when the “mean particle size” is well within the range considered to be injectable into wood.

The milling media, also called grinding media or milling beads, is central to this invention. The selection of milling media is expressly not routine optimization. The use of this media allows an average particle size and a narrow particle size distribution that had previously not been obtainable in the art, nor did the results in the prior art allow one to predict the unexpected results we obtained.

A major contribution of this invention is a method of preparing a particulate biocide product having a d₅₀ equal to or less than about 1 micron, comprising the steps of: 1) providing the solid metal or organic biocide, and a liquid comprising a surface active agent, to a mill; providing a milling media comprising an effective amount of milling beads having a diameter between about 0.01 mm and about 0.8 mm, preferably between about 0.1 mm and about 0.7 mm, more preferably between about 0.1 mm and about 0.5 mm, wherein the milling beads have a density greater than about 2.5 grams/cm³, preferably equal to or greater than 3.5 grams/cm³, more preferably equal to or greater than 3.8 grams/cm³, most preferably equal to or greater than 5.5 grams/cm³, for example a zirconia bead having a density of about 6 grams/cm³; and 2) wet milling the material at high speed, for example between 300 rpm and 6000 rpm, more preferably between 1000 rpm and 4000 rpm, for example between about 2000 rpm and 3600 rpm, where milling speed is provided for a laboratory scale ball mill, for a time sufficient to obtain a product having a mean volume particle diameter of about 1 micron or smaller, for example between about 5 minutes and 300 minutes, preferably from about 10 minutes to about 240 minutes, and most preferably from about 15 minutes to about 60 minutes. As little as 5% by volume of the milling media need be within the preferred specifications for milling some materials, but better results are obtained if greater than 10% by weight, preferably greater than 25% by weight, for example between 40% and 100% by weight of the milling material is within the preferred specifications. For milling material outside the preferred specifications, advantageously this material has a density greater than 3 grams/cm³ and a diameter less than 4 mm, for example 1 or 2 mm zirconia or zirconium silicate milling beads.

The milling media advantageously comprises or consists essentially of a zirconium-based material. The preferred media is zirconia (density about 6 g/cm³), which includes preferred variants such as yttria stabilized tetragonal zirconium oxide, magnesia stabilized zirconium oxide, and cerium doped zirconium oxide. For some biocides, zirconium silicate (density about 3.8 g/cm³) is useful. However, for several biocides such as chlorothalonil, zirconium silicate will not achieve the required action needed to obtain the narrow sub-micron range of particle sizes in several preferred embodiments of this invention. In an alternate embodiment, at least a portion of the milling media comprises or consists essentially of metallic material, e.g., steel. The milling medium is a material having a density greater than about 2.5 g/cm³, preferably at least about 3.8 g/cm³, more preferably greater than about 5.5 g/cm³, for example at least about 6 g/cm³.

Not all the milling media need be the preferred material, e.g., having a preferred diameter between 0.1 mm and 0.8 mm, preferably between 0.1 mm and 0.7 mm, more preferably between 0.1 mm and 0.5 mm, and having a preferred density equal to or greater than 3.5 grams/cm³, preferably greater than or equal to 5.5 grams/cm³, more preferably greater than or equal to 6 grams/cm³. In fact, as little as 10% of this media will provide the effective grinding. The amount of the preferred milling media, based on the total weight of media in the mill, can be between 5% and 100%, is advantageously between 10% and 100%, and is preferably between 25% and 90%, for example between about 40% and 80%. Media not within the preferred category can be somewhat larger, say 1 mm to 4 mm in diameter, preferably from 1 mm to 2 mm in diameter, and advantageously also has a density equal to or greater than 3.5 grams/cm³.

### Particle Size

As used herein, particle diameters may be expressed as “dₓₓ” where the “xx” is the weight percent (or alternately the volume percent) of that component having a diameter equal to or less than the dₓₓ. For example, the d₅₀ is the diameter where 50% by weight of the component is in particles having diameters equal to or lower than the d₅₀, while just under 50% of the weight of the component is present in particles having a diameter greater than the d₅₀. Particle diameter is preferably determined by Stokes Law settling velocities of particles in a fluid, for example with a Model LA 700 or a CAPA™ 700 sold by Horiba and Co. Ltd., or a Sedigraph™ 5100T manufactured by Micromeritics, Inc., which uses x-ray detection and bases calculations of size on Stoke's Law, to a size down to about 0.2 microns. Smaller sizes are preferably determined by a dynamic light scattering method, preferably with a Coulter™ counter.

In certain embodiments of the invention, the d95 of the solid particles in the wood preservation formulations of the invention is less than about 10 microns; or less than about 5 microns; or less than about 2 microns; or less than about 1 micron; or less than about 0.5 microns; or less than about 0.2 microns; or less than about 0.1 microns.

In certain embodiments of the invention, the mean particle size of the solid particles in the wood preservation formulations of the invention is from about 20 nm to about 100 nm; or about 20 nm to about 200 nm; or about 20 nm to about 500 nm; or about 50 nm to about 200 nm; or about 50 nm to about 300 nm; or about 50 nm to about 500 nm; or about 100 nm to about 500 nm.

### Copper Content of Treated Wood Products

In certain embodiments, the copper (or other metal, including, but not limited to zinc, iron, or silver) content of the wood product treated using the compositions of the invention is less than about 16 Kg/m³; or less than about 10 Kg/m³; or less than about 5 Kg/m³; or less than about 1 Kg/m³. As used herein, the amount of copper (or other metal, including, but not limited to zinc, iron, or silver) in treated wood is the amount of elemental copper (or other metal, including, but not limited to zinc, iron, or silver) present in the wood.

### Solvent Carrier

The solvent disclosed in the current invention is a hydrocarbon solvent with low content of aromatics. Hydrocarbon solvents, which are a petroleum derivative, are a relatively small group of products that are produced through the distillation of petroleum crude oil. Generally speaking, generic hydrocarbon solvents are a complex mixture of hydrocarbons and contain aliphatic compounds, such as saturated or unsaturated linear, branched and/or cyclic alkanes, alkynes, paraffinic, naphthenic acid and a certain level of aromatic components. The presence of aromatic compounds, such as alkylaromatics, benzene and polynuclear aromatics, in an otherwise aliphatic hydrocarbon solvent will have less desirable characteristics, such as increased odor or greater degree of human health concerns. In addition, the presence of aromatics will change the physical/chemical properties of the hydrocarbon solvent properties, for example, increased polarity. In the present invention, hydrocarbon solvents with low aromatics are used in the composition. They are derived from petroleum crude oil or from synthetic processes. We have surprisingly found that, in addition to much minimized odor and reduced health concern, low aromatic hydrocarbon solvents can facilitate the wetting/dispersing of copper compounds during the milling process and maintain particle stability during storage and during vacuum/pressure treating process.

The hydrocarbon solvents disclosed in the current invention will generally have less than about 22%, or less than about 15%, or less than about 8%, or less than about 1% aromatics by weight, preferably less than about 0.1% aromatics, and more preferably contain essentially 0% aromatics.

Examples of the low aromatic hydrocarbon solvents include, but are not limited to, paraffinic saturated alkanes, unsaturated alkenes and unsaturated alkynes (e.g. acetylene). Saturated alkanes include branched or isoalkanes (isoparaffinic), cyclic alkanes linear or normal alkanes (hexane and heptane). Unsaturated alkanes (olefins) include branched or isoalkanes, cyclic alkenes (e.g. cyclohexene) unsaturated alkynes and linear or normal alkenes (e.g. ethylene, propylene).

The low aromatic hydrocarbon solvents of the current invention have a minimum flash point of about 20° C., or about 30° C., or about 40° C., or about 60° C., or about 80° C., or about 100° C., or about 120° C., or about 140° C. or higher. In other embodiments, the low aromatic hydrocarbon solvents of the invention may have a flash point from about 20° C. to about 30° C., or about 20° C. to about 40° C., or about 20° C. to about 60° C., or about 20° C. to about 80° C., or about 20° C. to about 100° C., or about 20° C. to about 120° C., or about 20° C. to about 140° C. As used herein, the term “flash point” refers to the lowest temperature at which vapors of a volatile material will ignite, when given an ignition source.

The low aromatic hydrocarbon solvents of the invention have a boiling point range of about 40° C. to about 300° C., or about 60° C. to about 95° C., or about 130° C. to about 270° C., or about 130° C. to about 185° C., or about 140° C. to about 200° C., or about 150° C. to about 190° C., or about 180° C. to about 220° C., or about 190° C. to about 250° C. or about 220° C. to about 270° C.

Examples of commercially available hydrocarbon solvents with low aromatic content include, but are not limited to, Exxsol D dearomatized hydrocarbon fluids and Isopar isoparaffinic fluids manufactured by ExxonMobil, Shellsol D (de-aromatized) grades and Shellsol OMS isoparaffinic solvents manufactured by Shell Chemicals, Nessol Solvents manufactured by Neste, and MaxSolv manufactured by Resolute.

Examples of Exxsol D solvents are Exxol D30, D155/170, D40, D180/200, D60, D80, D220/240, D100, D100S, D120, D140. The physical chemical properties of these solvents are given as below:

Exxsol Solvents

| | | | | Exxsol | | | | | | | |
|---|---|---|---|---|---|---|---|---|---|---|---|
| | Exxsol | Exxsol | Exxsol | D180/200 | Exxsol | Exxsol | Exxsol | Exxsol | Exxsol | Exxsol | Exxsol |
| | D30 | D155/170 | D40 | SP | D60 | D80 | D220/240 | D100 | D100S | D120 | D140 |
| Alternate | N/A | N/A | N/A | N/A | N/A | N/A | N/A | N/A | N/A | N/A | N/A |
| Name | | | | | | | | | | | |
| CAS No | N/A | N/A | N/A | 64742- | 64742- | 64742- | 64742- | 64742- | 64742- | 64742- | 64742- |
| | | | | 48-9 | 48-9 | 47-8 | 47-8 | 47-8 | 47-8 | 47-8 | 46-7 |
| Distillation | 143-165 | 160-174 | 160-190 | 188-202 | 187-216 | 205-237 | 224-252 | 240-267 | 240-266 | 263-297 | 285-318 |
| Range (° C.) | | | | | | | | | | | |
| Flash Point | 29 | 41 | 42 | 63 | 63 | 76 | 90 | 102 | 102 | 120 | 138 |
| (° C.) | | | | | | | | | | | |
| Aromatic | 0.001 | 0.006 | 0.003 | 0.03 | 0.06 | 0.06 | 0.2 | 0.4 | 0.07 | 0.6 | 1.0 |
| Content (wt %) | | | | | | | | | | | |
| Aniline Point | 64 | 66 | 67 | 69 | 70 | 76 | 76 | 78 | 78 | 83 | 88 |
| (° C.) | | | | | | | | | | | |
| Density | 0.762 | 0.771 | 0.775 | 0.789 | 0.792 | 0.804 | 0.810 | 0.817 | 0.816 | 0.828 | 0.834 |
| (@ 15° C.) | | | | | | | | | | | |
| Evap Rate | 44 | 21 | 14 | 4.9 | 3.4 | <1 | <1 | <1 | <1 | <1 | <1 |
| (nButAc = 100) | | | | | | | | | | | |

### Biodegradable Organic Solvent Carriers For Wood Preservation Vegetable Oil

Vegetable oil generally refers to the compounds extracted from plants. The compounds are primarily triglyceride-based, and present as either liquid or fatty waxy or solid state at room temperature. Vegetable oils that are waxy or solid at ambient condition are also called vegetable fats. In Addition, vegetable oil contains both saturated and unsaturated carbon—carbon double bonds.

Unsaturated vegetable oils can be transformed through partial or complete hydrogenation into oils of higher melting point. The hydrogenation process involves sparging the oil at high temperature and pressure with hydrogen in the presence of a catalyst, typically a nickel based compound. As each carbon—carbon double-bond is chemically reduced to a single bond, two hydrogen atoms each form single bonds with the two carbon atoms to increase its degree of saturation. An oil may be hydrogenated to increase resistance to rancidity (oxidation) or to change its physical characteristics. As the degree of saturation increases, the oil's viscosity and melting point increase.

Non-limiting examples of vegetable oils are linseed oil, coconut oil, corn oil, cottonseed oil, palm oil, canola oil, palm kernel oil, olive oil, peanut oil, rapeseed oil, safflower oil, sesame oil, soybean oil, sunflower oil, castor oil, tung oil, poppyseed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

Synthetic tetraesters, which are similar to vegetable oils but with four fatty acid chains compared to the normal three found in a natural ester, are manufactured by Fischer esterification. Tetraesters generally have high stability to oxidation and have found use as engine lubricants. Vegetable oil is being used to produce biodegradable organic solvent carrier.

Renewable oil sources and Biodiesel: Renewable oil (renewable resource oil) is derived from sustainable and renewable sources of fatty acids and resins, such as tall oil. Tall oil, also called “liquid rosin” or tallol, is a yellow-black liquid obtained as a by-product of wood pulping process. Tall oil is the third largest chemical by-product in a Kraft mill after lignin and hemicellulose; the yield of crude tall oil from the process is in the range of 30-50 kg/ton pulp, and it has been produced commercially since the 1930s. Biodiesel refers to a vegetable oil- or animal fat-based diesel fuel consisting of long-chain alkyl (methyl, ethyl, or propyl) esters. Biodiesel is typically made by chemically reacting lipids (e.g., vegetable oil, soybean oil,[1] animal fat (tallow[2][3])) with an alcohol producing fatty acid esters.

### Dispersants

The present invention also contains a solvent-borne dispersant. The preferred dispersant is a polymeric dispersant with a pigment affinity group, such as a hydroxyl group, carboxylic acid group, sulfonate group, amine functional group or quaternary ammonium functional group. The polymeric dispersants that are used in this invention can be copolymers that are soluble or at least partially soluble in the low aromatic hydrocarbon solvents.

Examples of co-polymer dispersants include, but are not limited to, copolymers with pigment affinity groups, polycarboxylate ethers, modified polyacrylates, acrylic polymer emulsions, modified acrylic polymers, poly carboxylic acid polymers and their salts, modified poly carboxylic acid polymers and their salts, fatty acid modified polyesters, aliphatic polyethers or modified aliphatic polyethers, polyetherphosphates, solutions of polycarboxylate ethers, sodium polyacrylates, sodium polymethacrylates, modified polyether or polyester with pigment affinity groups, fatty acid derivatives, urethane copolymers or modified urethane copolymers, acrylic acid/maleic acid copolymers, polyvinyl pyrrolidones or modified polyvinyl pyrrolidones, modified maleic anhydride/styrene copolymers, lignins and the like.

Examples of commercially available solvent borne dispersants include, but are not limited to, the Disperbyk dispersant series, such as DISPERBYK 103, 108, 111, 118, 142, 168, 180, 410, 411, 2008, 2022, 2055, 2152, 2155 and 2164; the Tego Dispersant series, such as TEGO Disperse 1010, 650, 652, 656, 670, 671, 672, 685, 688, 690 and 710; the EFKA dispersant series, such as EFKA 4008, 4009, 4010, 4015, 4020, 4046, 4047, 4050, 4055, 4061,4063, 4080, 4300, 4310, 4320, 4330, 4340, 4400, 4401, 4402, 4403, 4510, 4530, 4550, 4570. 4590, 5010, 5044, 5054, 5055, 5063, 5065, 5066, 5070, 5071, 5207, 5210, 5215, 5220, 5244, 5744, 6050, 6230, 6220, 6225, 1016, 1101, 1500, 1501, 1502, 1503, 6622, 6700, 6950, 6043, 6745, 6780, 6782, FA 4600, FA 4601, FA 4620, FA 4642, FA 4644, FA 4650, FA 4654, FA 4654EM, FA 4660, FA 4663, FA 4665, and FA 4671; the Solsperse series, such as Solsperese 3000, 5000S, 8000, 9000, 11200, 13300, 13400, 13650, 13940, 16000, 17000, 17940, 18000, 19000, 21000, and 22000. Dispersants from Stepan Company, such as Bio-softN1-3, Bio-soft N91-2.5, Bio-soft N-411, Makon NF-12, and G-3300. AkzoNobel dispersant Phospholan PS 131.

### Stable Dispersions

Dispersing agents aid particulate dispersion and prevent aggregation of particulates. Sub-micron sized particulates have a tendency to form much larger aggregates. Aggregates as used herein are physical combinations of a plurality of similarly-sized particles, often brought together by van der Waals forces or electrostatic forces. If aggregates are allowed to form they often can age into a stable aggregate that cannot be readily injectable, or may be a size to make the aggregates visible, there giving undesired color. In preferred embodiments of the invention at least 30%, preferably at least 60%, more preferably at least 90% by weight of the stable dispersion of particulate copper compounds (or metal compound) are mono-disbursed, i.e. are not in aggregates. Further, the solid particles advantageously do not tend to agglomerate when injected into the wood.

Accordingly, as used herein, a stable dispersion is one in which the particle size of the metal compound, or copper compound remains substantially the same over time.

The exact usage level of dispersant depends upon the copper compound used and the particular solvent carrier. But generally speaking, the dispersant to copper compound ratio varies from about 1:500 to about 100: 1 weight/weight (wt/wt), or about 1:100 to about 10:1 wt/wt. The preferred dispersant to copper compound ratio is about 1: 20 to about 10:1 (wt/wt), and the most preferred ratio about 1:10 to about 1:1 (wt/wt).

### Other Biocides and Additives

The current AWPA method to determine the preservative biocide loading in treated wood is by taking samples from preservative treated wood samples, and then conducting chemical analysis to obtain a m/m % or wt/wt %, which can then be mathematically converted to another unit, pcf (pounds per cubic foot) or kg/m3 (kilograms per cubic meter) according to the wood density. AWPA Method M25-16 (Standard for Quality Control and Inspection of Preservative Treated Products for Residential and Commercial Use, which is incorporated herein by reference in its entirety) describes procedures for conducting retention analyses.

Other biocides, such as fungicides, bactericides, termiticides, and moldicides can be included in the current composition for treating wood. Examples of other biocides include, but are not limited to the following:

Boron compounds. Non-limiting examples of water soluble boron compounds include boric acid, sodium borates, such as sodium tetraborate decahydrate, sodium tetraborate pentahydrate, and disodium octaborate tetrahydrate (DOT), potassium borates. Non-limiting examples of water insoluble boron compounds include metal borate compounds such as calcium borate, borate silicate, aluminum silicate borate hydroxide, silicate borate hydroxide fluoride, hydroxide silicate borate, sodium silicate borate, calcium silicate borate, aluminum borate, boron oxide, magnesium borate, iron borate, copper borate, and zinc borate (borax).

Quaternary ammonium compounds. Non-limiting examples are: didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly(oxyethyl)ammonium propionate.

Triazole or imidazole compounds. Non-limiting examples are 1-[[2-(2,4-dichlorophenyl)-1,3-dioxolan-2-yl]methyl]-1H-1,2,4-triazole (azaconazole), 1-[(2RS,4RS:2RS,4SR)-4-bromo-2-(2,4-dichlorophenyl)tetrahydrofurfuryl]-1H-1,2,4-triazole (bromuconazole), (2RS,3RS;2RS,3SR)-2-(4-chlorophenyl)-3-cyclopropyl-1-(1H-1,2,4-triazol-1-yl)butan-2-ol (Cyproconazole), (2RS,3RS)-1-(2,4-dichlorophenyl)-4,4-dimethyl-2-(1H-1,2,4-triazol-1-yl)pentan-3-ol (diclobutrazol), cis-trans-3-chloro-4-[4-methyl-2-(1H-1,2,4-triazol-1-ylmethyl)-1,3-dioxolan-2-yl]phenyl 4-chlorophenyl ether (difenoconazole), (E)-(RS)-1-(2,4-dichlorophenyl)-4,4-dimethyl-2-(1H-1,2,4-triazol-1-yl)pent-1-en-3-ol (diniconazole), (E)-(R)-1-(2,4-dichlorophenyl)-4,4-dimethyl-2-(1H-1,2,4-triazol-1-yl)pent-1-en-3-ol (diniconazole-M), (2RS,3 SR)-1-[3-(2-chlorophenyl)-2,3-epoxy-2-(4-fluorophenyl)propyl]-1H-1,2,4-triazole (epoxiconazole), (RS)-1-[2-(2,4-dichlorophenyl)-4-ethyl-1,3-dioxolan-2-ylmethyl]-1H-1,2,4-triazole (etaconazole), (RS)-4-(4-chlorophenyl)-2-phenyl-2-(1H-1,2,4-triazol-1-ylmethyl)butyronitrile (fenbuconazole), 3-(2,4-dichlorophenyl)-6-fluoro-2-(1H-1,2,4-triazol-1-yl)quinazolin-4(3H)-one (fluquinconazole), bis(4-fluorophenyl) (methyl) (1H-1,2,4-triazol-1-ylmethyl)silane (flusilazole), (RS)-2,4′-difluoro-α-(1H-1,2,4-triazol-1-ylmethyl)benzhydryl alcohol (flutriafol), (2RS,5RS;2RS,5SR)-5-(2,4-dichlorophenyl)tetrahydro-5-(1H-1,2,4-triazol-1-ylmethyl)-2-furyl 2,2,2-trifluoroethyl ether (furconazole), (2RS,5RS)-5-(2,4-dichlorophenyl)tetrahydro-5-(1H-1,2,4-triazol-1-ylmethyl)-2-furyl 2,2,2-trifluoroethyl ether(furconazole-cis), (RS)-2-(2,4-dichlorophenyl)-1-(1H-1,2,4-triazol-1-yl)hexan-2-ol (hexaconazole), 4-chlorobenzyl (EZ)-N-(2,4-dichlorophenyl)-2-(1H-1,2,4-triazol-1-yl)thioacetamidate (imibenconazole), (1RS,2SR,5RS;1RS,2SR,5 SR)-2-(4-chlorobenzyl)-5-isopropyl-1-(1H-1,2,4-triazol-1-ylmethyl)cyclopentanol (ipconazole), (1RS,5RS;1RS,5SR)-5-(4-chlorobenzyl)-2,2-dimethyl-1-(1H-1,2,4-triazol-1-ylmethyl)cyclopentanol (metconazole), (RS)-2-(4-chlorophenyl)-2-(1H-1,2,4-triazol-1-ylmethyl)hexanenitrile (myclobutanil), (RS)-1-(2,4-dichloro-β-propylphenethyl)-1H-1,2,4-triazole(penconazole), cis-trans-1-[2-(2,4-dichlorophenyl)-4-propyl-1,3-dioxolan-2-ylmethyl]-1H-1,2,4-triazole (propiconazole), (RS)-2-[2-(1-chlorocyclopropyl)-3-(2-chlorophenyl)-2-hydroxypropyl]-2,4-dihydro-1,2,4-triazole-3-thione (prothioconazole), 3-(2,4-dichlorophenyl)-2-(1H-1,2,4-triazol-1-yl)-quinazolin-4(3H)-one (quinconazole), (RS)-2-(4-fluorophenyl)-1-(1H-1,2,4-triazol-1-yl)-3-(trimethylsilyl)propan-2-ol (simeconazole), (RS)-1-p-chlorophenyl-4,4-dimethyl-3-(1H-1,2,4-triazol-1-ylmethyl)pentan-3-ol (tebuconazole), propiconazole, (RS)-2-(2,4-dichlorophenyl)-3-(1H-1,2,4-triazol-1-yl)propyl 1,1,2,2-tetrafluoroethyl ether (tetraconazole), (RS)-1-(4-chlorophenoxy)-3,3-dimethyl-1-(1H-1,2,4-triazol-1-yl)butan-2-one (triadimefon), (1RS,2RS;1RS,2SR)-1-(4-chlorophenoxy)-3,3-dimethyl-1-(1H-1,2,4-triazol-1-yl)butan-2-ol (triadimenol), (RS)-(E)-5-(4-chlorobenzylidene)-2,2-dimethyl-1-(1H-1,2,4-triazol-1-ylmethyl)cyclopentanol (triticonazole), (E)-(RS)-1-(4-chlorophenyl)-4,4-dimethyl-2-(1H-1,2,4-triazol-1-yl)pent-1-en-3-ol (uniconazole), (E)-(S)-1-(4-chlorophenyl)-4,4-dimethyl-2-(1H-1,2,4-triazol-1-yl)pent-1-en-3-ol (uniconazole-P), and 2-(2,4-difluorophenyl)-1-(1H-1,2,4-triazole-1-yl)-3-trimethylsilyl-2-propanol. Other azole compounds include: amisulbrom, bitertanol, fluotrimazole, triazbutil, climbazole, clotrimazole, imazalil, oxpoconazole, prochloraz, triflumizole, azaconazole, simeconazole, and hexaconazole.

Isothiazolone compounds. Non-limiting examples are: methylisothiazolinone; 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, preferably 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, etc., more preferably 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone; 4,5-Dichloro-2-n-octyl-3(2H)-isothiazolone; 1,2-b enzisothiazolin-3-one.

Pyrethroid compounds include: acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen.

Other biocides include: imidachloprid; fipronil; cyfluthrin; bifenthrin; permethrin; cypermethrin; and chlorpyrifos, iodopropynyl butylcarbamate (IPBC); chlorothalonil; 2-(thiocyanatomethylthio) benzothiazole; alkoxylated diamines and carbendazim

In addition, other additives such as water repellents, anti-weathering agents, dimensional stabilizers, or fire retardants can be included in the composition for protecting wood. Non-limiting examples of water repellents include paraffin wax, olefin wax, petroleum wax, carnauba wax, polyethylene wax, silicone wax, polypropylene wax, PTFE wax and synthetic wax.

Penflufen: In certain embodiments, the invention is directed to wood preservative compositions comprising penflufen, methods of treating wood with said compositions, and wood treated with said compositions. In certain embodiments, wood treated with said compositions comprising penflufen, the amount of penflufen in said wood product is less than about 0.25% weight/weight, or is about 0.0001% to 0.10% weight/weight, or is about 0.001% to 0.05% weight/weight, or is about 0.005% to 0.025% weight/weight.

Non-limiting examples of anti-weathering agents include: pigments such as zinc oxide, zinc sulfide, iron oxide, carbon black, titanium dioxide; UV absorbers such as hydroxyl-substituted benzophenones, hydroxyphenyl benzotriazides, substituted acrylonitriles; UV stabilizers such as hindered amine light stabilizers (HALS); and anti-oxidants such as amines, imidiazoles or complex hindered phenolics.

Non-limiting examples of dimensional stabilization agents include: waxes such as paraffin wax, olefin wax, petroleum wax, carnauba wax, polyethylene wax, silicone wax, polypropylene wax, PTFE wax and synthetic wax, and polymers such as polystyrene, polyethylene, polypropylene, polyvinyl chloride, polyacrylonitrile, polyvinyl acetate, polyester, acrylic polymers, polyamide, polyurethane, phenolic novolacs, phenolic resoles, urea formaldehyde resins, melamine formaldehyde resins, epoxy resins, natural resins such as rosin and rosin esters, hydrocarbon resins, ketone resins, terpene resins, alkyd resins, silicone resins and silicate resins, and other water insoluble polymers.

Non-limiting examples of fire retardants are: metal hydroxides such as aluminum trihydroxide and magnesium hydroxide; antimony compounds such as antimony trioxide, antimony pentoxide and calcium antimonite; zinc compounds such as zinc stannate, zinc hydroxyl-stannate, zinc borate, zinc silicate, zinc phosphate, zinc oxide and zinc hydroxide; phosphorous based compounds such as phosphate esters red phosphorus melamine phosphate, zinc phosphate, calcium phosphate, magnesium phosphate and ethylenediamine phosphate; silicate compounds such as calcium silicate, silica, magnesium silicate and zinc silicate; halogenated compounds such as tetra bromo bisphenol A; nitrogen based compounds such as melamine and its salts, melamine borate and polyamides.

### Preparation of Concentrated Copper in Organic Solvent

The preparation of the concentrated copper in organic solvents comprises the following steps: (1). Premixing of the copper compounds with dispersants and solvents to form a liquid slurry; (2). Feed the slurry into the mill which is pre-filled with milling media; (3). Milling the slurry and monitor the particle size to the target particle size specification. Although the preferred solvents for making concentrated copper are low aromatic hydrocarbon carbon solvents as described and disclosed in this application, other solvents can also be used for making the concentrated copper formulation. Non-limiting examples of other organic solvents that can be used for making a concentrated copper formulation, either alone, or as mixtures include the follows:

Amines such as, for example: Diamylamine, Diethylamine, Diisopropylamine, Dimethylethylamine, Di-n-Butylamine, Mono-2-Ethylhexyamine, Monoamylamine, Monoethylamine 70%, Monoisopropylamine, Anhy., Mono-n-Butylamine, Triamylamine, Triethylamine, Tri-n-Butylamine, Dibutylaminoethanol, Diethylaminoethanol, Diethylaminoethoxyethanol, Diisopropylaminoethanol, Dimethylamino-2P, 77% Mixed, Dimethylamino-2-P, Anhy., Dimethylaminoethanol, Dimethylaminoethoxyethanol, Ethlylaminoethanol, Ethylaminoethanol, Mixed, Isopropylaminoethanol, Isopropylaminoethanol, Mixed, Methyldiethanolamine, Monomethylaminoethanol, Mono-n-Propylaminoethanol, n-Butylaminoethanol, n-Butyldiethanolamine, n-Butyldiethanolamine, Photo, t-Butylaminoethanol, t-butyldiethanolamine, Diethanolamine, Monoethanolamine, Triethanolamine, Triethanolamine 85%/99%, Diisopropanolamine, Monoisopropanolamine, Triisopropanolamine, Aminoethylethanolamine, Aminoethylpiperazine, Diethylenetriamine, Ethylenediamine, Piperazine 65%/Anhy., Piperazine, Tetraethylenepentamine, Triethylenetetramine, 3-Methoxypropylamine, AMP.RTM. Regular/95, Cyclohexylamine, Morpholine, Neutrol TE.RTM.

Glycols, such as, for example: Diethylene Glycol, Dipropylene Glycol, Ethylene Glycol, Glycerine 96%, 99%, U.S.P., Glycerine, Hexylene Glycol, Neol.RTM. Neopentyiglycol, Polyethylene Glycol, Polypropylene Glycol, Propylene Glycol Ind., U.S.P., Tetraethylene Glycol, Triethylene Glycol, Tripropylene Glycol.

Ketones such as, for example: Acetone, Cyclohexanone, Diacetone, DIBK-Diisobutyl Ketone, Isophorone, MAK-Methyl Amyl Ketone, MEK-Methyl Ethyl Ketone, MIAK-Methyl Isoamyl Ketone, MIBK-Methyl Isobutyl Ketone, MPK-Methyl Propyl Ketone.

Esters such as, for example: Amyl Acetate, Dibasic Ester, Ethyl Acetate, 2 Ethyl Hexyl Acetate, Ethyl Propionate, Exxate.RTM. Acetate Esters, Isobutyl Acetate, Isobutyl Isobuterate, Isopropyl Acetate, n-Butyl Acetate, n-Butyl Propionate, n-Pentyl Propionate, n-Propyl Acetate.

Alcohols such as, for example: Amyl Alcohol, Benzyl Alcohol, Cyclohexanol, Ethyl Alcohol-Denatured, 2-Ethyl Hexanol, Exxal 8.RTM. Isooctyl Alcohol, Exxal 10.RTM. Isodecyl Alcohol, Exxal 13.RTM. Tridecyl Alcohol, Furfuryl Alcohol, Isobutyl Alcohol, Isopropyl Alcohol 99% Anhy, Methanol, Methyl Amyl Alcohol (MIBC), n-Butyl Alcohol, n-Propyl Alcohol, Neodol.RTM. Linear Alcohol, Secondary Butyl Alcohol, Tertiary Butyl Alcohol, Tetrahydrofurfryl Alcohol, Texanol Ester Alcohol.RTM., UCAR Filmer IBT.RTM.

Halogenated Carriers such as, for example: Methylene Chloride, Monochlorobenzene, Orthodichlorobenzene, Perchloroethylene, Trichloroethylene, Vertrel.RTM. Hydrofluorocarbon.

Aliphatic Carriers such as, for example: Heptane, Hexane, Kerosene, Lacquer Diluent, Mineral Seal Oil, Mineral Spirits, n-Pentane, OMS-Odorless Mineral Spirits, Rubber Solvent, 140 Solvent, 360 Solvent, Textile Spirits.RTM., VM&P.

Aromatic Carriers such as, for example: Aromatic 100, Aromatic 150, Aromatic 200, Heavy Aromatic Solvent, Panasol.RTM., Toluene, Xylene.

Terpene Carriers such as, for example: Alpha-Pinene, Wood, Dipentene 122.RTM., D-Limonene, Herco.RTM. Pine Oil, Solvenol.RTM., Steam Distilled Turpentine, Terpineol.RTM., Yarmor.RTM. 302, 302-W Pine Oil.

Other Carriers, including, for example: mineral oil, linseed oil, olive oil, vegetable oil, methoxypropyl acetate, isopropyl alcohol, castor oil, Arconate HP.RTM. Propylene Carbonate, #2 fuel oil, Cypar.RTM. Cycloparaffin Solvent, DMF-dimethyl formamide, formamide, Exxprint.RTM. Ink Oil/Solvent, furfural, Isopar.RTM. Isoparaffin Solvent, MTBE-methyl tert-butyl ether, NMP-N-methyl pyrrolidone, Norpar.RTM. Normal Paraffin Solvent, Proglyde DMM.RTM. Glycol Diether, THF-tetrahydrofuran, Varsol.RTM. Aliphatic Solvent.

### Preparation of Copper Treating Solution in Low Aromatic Hydrocarbon Solvent Carrier

When preparing treating solutions for treating wood or wood based products, the concentrated form of solvent-borne dispersed copper compounds prepared as above is diluted with the low aromatic hydrocarbon solvent carriers. The elemental copper concentration in the final treating solutions can vary from about 0.05% wt/wt to about approximately 5.0% wt/wt. The preferred elemental copper concentration in the treating solution is in the range of about 0.50% wt/wt to about 3.0% wt/wt.

When an organic biocide is added to the above dispersed copper treating solution, the organic biocide can be added directly to the treating solution if the biocide is readily soluble in the treating solution. Alternatively, the organic biocide can be pre-solubilized in an organic solvent and then added to the dispersed copper solution, where the organic solvent for dissolving the organic biocide is compatible or miscible with the low aromatic hydrocarbon solvent. Non-limiting examples of the organic solvent are disclosed in the above section.

### Treating and Application Process

The wood preservative compositions of the invention can be applied to wood through dipping, brushing, spraying, vacuum and/or pressure treatment, or any other known method in the art. Wood or wood products comprising micronized copper compounds in accordance with the present invention may be prepared by subjecting the present composition into wood through a vacuum and/or pressure process. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are well known to those skilled in the art. Depending upon the treating process used, the solution uptake by the treated wood is less than about 600 L/m³ (liters per cubic meter), less than about 500 L/m³, less than about 400 L/m³, less than about 300 L/m³, less than about 200 L/m³, less than about 100 L/m³, less than about 50 L/m³, or less than about 10 L/m³.

In another embodiment, the treating liquid may be applied by a microwave or radio frequency treating process. In this process, the wood substrate is first heated using a radio frequency or microwave energy. The temperature of the heated target zone can vary from about 40° C. to about 300° C., and more preferably about 80° C. to about 100° C. Immediately after the heating, a liquid formulation comprising pyrazole and isothiazolinone is contacted with the substrate. The temperature of the liquid formulation is below that of the heated target zone at the time the composition is applied, the difference between the temperatures of the composition and the heated target zone being sufficient to reduce pressure in the substrate after the composition is applied. Various frequencies of radio or microwave energy may be used. The frequency of the radio frequency or microwave energy can vary from about 0.1 MHz to about 100 MHz, preferably between about 10 MHz and about 50 MHz, a more preferably from about 20 MHz to about 40 MHz. Skilled persons may readily appreciate appropriate wavelengths outside this range. Depending upon the radio frequency or heating duration used, the solution uptake by the treated wood is generally less than about 600 L/m³, less than about 400 L/m³, less than about 300 L/m³, less than about 200 L/m³, less than about 100 L/m³, less than about 50 L/m³, or less than about 10 L/m³.

In certain embodiments, the compositions of the present invention can be applied to the wood surface through an external coating treatment.

In certain embodiments of the invention, an advantage of the invention is that the wood products treated with the wood preservative compositions of the invention do not require subsequent drying after treatment with the wood preservative compositions of the invention. Such drying steps include vacuum treatment, heating, kiln drying, and air drying.

### Treated Wood Products

In certain embodiments of the invention, the treated wood products of the invention do not have an oily texture to the touch. In certain embodiments of the invention, the treated wood products are substantially free of odor, such as a chemical odor.

In certain embodiments of the invention, the treated wood products of the invention exhibit increased dimensional stability compared to untreated wood products, or wood products treated with wood preservative compositions comprising an aqueous carrier or solvent. The term “increased dimensional stability” refers to reduced swelling, checking, splitting, warping, or twisting of treated wood products upon storage after treatment with a wood preservative composition of the invention.

### Wood Products and Species

The compositions of the present invention are useful as wood preservatives for protecting wood and/or wood based products, such as, for example, lumber, timbers, particle board, plywood, laminated veneer lumber (LVL), oriented strained board (OSB), utility poles, wood bridges. from decay and termite attack. Non-limiting examples wood species include: southern pine, radiata pine, Eucalyptus, Caribbean pine, ponderosa pine, red pine, eastern white pine, Scots pine, jack pine, lodgepole pine, spruce-pine-fir, Douglas fir, hem fir, eastern hemlock, western red cedar, maple, oak.

The compositions of the present invention can also be used for supplemental or remedial treatment of wood in service, such as utility poles and railroad ties. When used as a remedial preservative, the compositions can be in the form of paste- or grease-type of formulation, if desired, such that the formulation has an adhesive nature and is easy to apply to a desired location. When making a paste or grease type of formulation, 0.5% to about 30% by weight of an metal clay thickening agent, or a mixture of such thickening agents, is often used. The metal clay thickening agents include a fibrous structure type such as attapulgite clay and sepiolite clay, a non-crystal structure type such as allophone, and mixed layer structure type such as montmorillonite and kaolinte and the above layer structure types. Examples of metal clay minerals include,but are not limited to, attapulgite, dickite, saponite, montmorillonite, nacrite, kaolinite, anorthite, halloysite, metahalloysite, chrysotile, lizardite, serpentine, antigorite, beidellite, stevensite, hectonite, smecnite, nacrite and sepiolite, montmorillonite, sauconite, stevensite, nontronite, saponite, hectorite, vermiculite, smecnite, sepiolite, nacrite, illite, sericite, glauconite-montmorillonite, roselite-montmorillonite, Bentone 38 (hectorite) and Bentone 34 (bentonite), chlorite-vermiculite, illite-montmorillonite, halloysite-montmorillonite, kaolinite-montmorillonite. The clay minerals employed in the compositions of the present invention also contain exchangeable cations including, but not limited to, aluminum ions, protons, sodium ions, potassium ions, calcium ions, magnesium ions, lithium ions, and the like. Among the above metal clay minerals, attapulgite, hectorite, bentonite, montmorillonite, sauconite, smecnite, stevensite, beidellite, nontronite, saponite, hectorite, vermiculite, nacrite, and sepiolite are particularly preferable for the present invention.

### EXAMPLES

The following examples are merely indicative of the nature of the present invention, and should not be construed as limiting the scope of the invention, nor of the appended claims, in any manner. Examples 1-8 demonstrate the preparation of the concentrated particulate copper dispersion in solvent. Examples 9-29 demonstrate the preparation of the treating solutions of the solvent borne particulate copper and the use of treating solutions in treating wood.

### Example 1

Two hundred (200.0) grams of basic copper carbonate were added to a container contain 132 grams' low aromatic content (<1.0%) solvent and 68 grams of a commercially available solvent borne dispersing/wetting agent. The solvent has a flash point of about 80° C. The mixture was mechanically stirred for 5 minutes and then placed in grinding mill. The mixture was ground for about 2 hours, and a stable dispersion containing about 50% basic copper carbonate was obtained with an average particles size of 0.31 micrometers.

### Example 2

Two hundred (200.0) grams of basic copper carbonate were added to a container contain 140 grams' low aromatic content (<0.1%) solvent and 60 grams of a commercially available solvent borne dispersing/wetting agent. The solvent has a flash point of about 60° C. The mixture was mechanically stirred for 5 minutes and then placed in grinding mill. The mixture was ground for about 2 hours, and a stable dispersion containing about 50% basic copper carbonate was obtained with an average particles size of 0.34 micrometers.

### Example 3

Two hundred (200.0) grams of basic copper carbonate were added to a container contain 140 grams' low aromatic content (<1.0%) solvent and 60 grams of a commercially available solvent borne dispersing/wetting agent. The solvent has a flash point of about 80° C. The mixture was mechanically stirred for 5 minutes and then placed in grinding mill. The mixture was ground for about 2 hours, and a stable dispersion containing about 50% basic copper carbonate was obtained with an average particles size of 0.17 micrometers.

### Example 4

Two hundred (200.0) grams of basic copper carbonate were added to a container contain 140 grams' low aromatic content (<0.1%) solvent and 60 grams of a commercially available solvent borne dispersing/wetting agent. The solvent has a flash point of about 80° C. The mixture was mechanically stirred for 5 minutes and then placed in grinding mill. The mixture was ground for about 2 hours, and a stable dispersion containing about 50% basic copper carbonate was obtained with an average particles size of 0.34 micrometers.

### Example 5

Two hundred (200.0) grams of basic copper carbonate were added to a container contain 170 grams' low aromatic content (<0.1%) solvent and 30 grams of a commercially available solvent borne dispersing/wetting agent. The solvent has a flash point of about 80° C. The mixture was mechanically stirred for 5 minutes and then placed in grinding mill. The mixture was ground for about 2 hours, and a stable dispersion containing about 50% basic copper carbonate was obtained with an average particles size of 0.30 micrometers.

### Example 6

Two hundred (200.0) grams of basic copper carbonate were added to a container contain 180 grams' low aromatic content (<0.1%) solvent and 20 grams of a commercially available solvent borne dispersing/wetting agent. The solvent has a flash point of about 80° C. The mixture was mechanically stirred for 5 minutes and then placed in grinding mill. The mixture was ground for about 2 hours, and a stable dispersion containing about 50% basic copper carbonate was obtained with an average particles size of 0.33 micrometers.

### Example 7

Two hundred (200.0) grams of basic copper carbonate were added to a container contain 140 grams' low aromatic content (<0.1%) solvent and 60 grams of a commercially available solvent borne dispersing/wetting agent. The solvent has a flash point of about 100° C. The mixture was mechanically stirred for 5 minutes and then placed in grinding mill. The mixture was ground for about 2 hours, and a stable dispersion containing about 50% basic copper carbonate was obtained with an average particles size of 0.30 micrometers.

### Example 8

Two hundred (200.0) grams of basic copper carbonate were added to a container contain 140 grams' low aromatic content (<1.0%) solvent and 60 grams of a commercially available solvent borne dispersing/wetting agent. The solvent has a flash point of about 100° C. The mixture was mechanically stirred for 5 minutes and then placed in grinding mill. The mixture was then ground for about 2 hours, and a stable dispersion containing about 50% basic copper carbonate was obtained with an average particles size of 0.20 micrometers.

### Example 9

A preservative treating composition was prepared by adding 124.20 g of dispersion made from Example 4 to 3375.80 g of a hydrocarbon solvent (<1.0% aromatic content) with flash point of about 80° C. The resulting fluid contained about 1.0% elemental copper by weight. This fluid is then used to treat a 1.5×5.5×10″ southern pine wood stakes using the full-cell process wherein the wood was initially placed under a vacuum of 25-30″ Hg for 15 minutes, followed by the addition of treating solution. The system was then pressurized for 60 minutes at 120 psi. A final vacuum of 30″ Hg for 15 minutes was applied to the wood to remove residual liquid. The wood was found to have a clear surface and negligible odor, and treating solution showed good stability with stable particle size.

### Example 10

A preservative treating composition was prepared by adding 124.20 g of dispersion made from Example 4 to 3375.80 g of a hydrocarbon solvent (<0.1% aromatic content) with flash point of about 80° C. The resulting fluid contained about 1.0% elemental copper by weight. This fluid is then used to treat a 1.5×5.5×12″ southern pine wood stakes using the full-cell process wherein the wood was initially placed under a vacuum of 25-30″ Hg for 15 minutes, followed by the addition of treating solution. The system was then pressurized for 60 minutes at 120 psi. A final vacuum of 30″ Hg for 15 minutes was applied to the wood to remove residual liquid. The wood was found to have a clear surface and negligible odor, and treating solution showed good stability with stable particle size. The treated wood was cut along the cross section, and then sprayed with copper indicator according to AWPA Standard Method A72-12. The copper was found to penetrate through the cross section.

### Example 11

A preservative treating composition was prepared by adding 124.20 g of dispersion made from Example 4 to 3375.80 g of a hydrocarbon solvent (<1.0% aromatic content) with flash point of about 100° C. The resulting fluid contained about 1.0% elemental copper by weight. This fluid was then used to treat a 1.5×5.5×10″ southern pine wood stakes using the full-cell process wherein the wood was initially placed under a vacuum of 25-30″ Hg for 15 minutes, followed by the addition of treating solution. The system was then pressurized for 60 minutes at 120 psi. A final vacuum of 30″ Hg for 15 minutes was applied to the wood to remove residual liquid. The wood was found to have a clear surface and negligible odor, and treating solution showed good stability with stable particle size.

### Example 12

A preservative treating composition was prepared by adding 124.20 g of dispersion made from Example 4 to 3375.80 g of a hydrocarbon solvent (<0.1% aromatic content) with flash point of about 100° C. The resulting fluid contained about 1.0% elemental copper by weight. This fluid is then used to treat a 1.5×5.5×12″ southern pine wood stakes using the full-cell process wherein the wood was initially placed under a vacuum of 25-30″ Hg for 15 minutes, followed by the addition of treating solution. The system was then pressurized for 60 minutes at 120 psi. A final vacuum of 30″ Hg for 15 minutes was applied to the wood to remove residual liquid. The wood was found to have a clear surface and negligible odor, and treating solution showed good stability with stable particle size.

### Example 13

A preservative treating composition comprising 0.40% Cu and 0.016% Tebuconazole was prepared by mixing the copper concentrate made from Example 4 and a tebuconazole solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 14

A preservative treating composition comprising 0.48% Cu and 0.019% Tebuconazole was prepared by mixing the copper concentrate made from Example 4 and a tebuconazole solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 15

A preservative treating composition comprising 0.74% Cu and 0.030% Tebuconazole was prepared by mixing the copper concentrate made from Example 4 and a tebuconazole solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 16

A preservative treating composition comprising 0.99% Cu and 0.040% Tebuconazole was prepared by mixing the copper concentrate made from Example 4 and a tebuconazole solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 17

A preservative treating composition comprising 0.42% Cu and 0.0084% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 18

A preservative treating composition comprising 0.42% Cu and 0.0056% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 19

A preservative treating composition comprising 0.41% Cu and 0.0041% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 20

A preservative treating composition comprising 0.42% Cu and 0.0034% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 21

A preservative treating composition comprising 0.64% Cu and 0.013% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 22

A preservative treating composition comprising 0.65% Cu and 0.0086% penflufen was prepared by mixing the copper concentrate made from Example 4 and a penflufen solution in a hydrocarbon solvent carrier (<0.1% aromatic content) with flash point of about 80° C. The prepared treating fluid was used to treat southern pine sapwood stakes measuring 19 mm×19 mm×960 mm using a full-cell process wherein the wood was initially placed under a vacuum of 25-30″ Hg for 15 minutes, followed by the addition of treating solution. The system was then pressurized for 30 minutes at 100 psi. The treated wood stakes were found to have a clear surface. The stakes were cut into 19 mm×19 mm×450 mm size and installed in two outdoor testing sites for long-term performance test against fungal decay and termite.

### Example 23

A preservative treating composition comprising 0.50% Cu and 0.0050% penflufen is prepared by mixing the copper concentrate made from Example 4 and a penflufen solution in a hydrocarbon solvent carrier (<0.1% aromatic content) with flash point of about 80° C. The prepared treating fluid is used to treat southern pine sapwood stakes measuring 19 mm×19 mm×960 mm using a full-cell process wherein the wood was initially placed under a vacuum of 25-30″ Hg for 15 minutes, followed by the addition of treating solution. The system is then pressurized for 30 minutes at 100 psi. The treated wood stakes have a clear surface. The stakes are cut into 19 mm×19 mm×450 mm size and installed in two outdoor testing sites for long-term performance test against fungal decay and termite.

### Example 24

A preservative treating composition comprising 0.65% Cu and 0.0052% penflufen is prepared by mixing the copper concentrate made from Example 4 and a penflufen solution in a hydrocarbon solvent carrier (<0.1% aromatic content) with flash point of about 80° C. The prepared treating fluid is used to treat southern pine sapwood stakes measuring 19 mm×19 mm×960 mm using a full-cell process wherein the wood was initially placed under a vacuum of 25-30″ Hg for 15 minutes, followed by the addition of treating solution. The system is then pressurized for 30 minutes at 100 psi. The treated wood stakes have a clear surface. The stakes are cut into 19 mm×19 mm×450 mm size and installed in two outdoor testing sites for long-term performance test against fungal decay and termite.

### Example 25

A preservative treating composition comprising 2.5% Cu and 0.10% Tebuconazole is prepared by mixing a 12.86% copper concentrate and a tebuconazole solution in a hydrocarbon solvent carrier (butanol) and then diluted with white spirits solvent (aromatic content of <20%). The prepared treating fluid is used to treat radiata pine decking measuring 90 mm×22 mm×900 mm using a double vacuum process wherein the wood is initially placed under a vacuum of −60 kPa for 1 minute, followed by the addition of treating solution. The system is then returned to atmospheric pressure for 2mins, the solution removed from the treatment vessel and a final vacuum of −85 kPa for 10 minutes is applied. The treated wood has a clear surface. A copper spot test shows penetration to be all through the sapwood with uptake of preservative ranging from 16-50 L/m3.

### Example 26

A preservative treating composition comprising 2.5% Cu and 0.10% Tebuconazole is prepared by mixing a 12.86% copper concentrate and a tebuconazole solution in a hydrocarbon solvent carrier (butanol) and then diluted with white spirits solvent (aromatic content of <20%, flash point 40-42° C.). The prepared treating fluid is used to treat radiata pine samples measuring 90 mm×45 mm×900 mm using a vacuum and low pressure process wherein the wood is initially placed under a vacuum of −70 kPa for 1 minute, followed by the addition of treating solution. The system is then pressurized for 2 minutes at 50 kPa. The treated wood has a clear surface. A copper spot test shows penetration to be all through the sapwood with uptake of preservative ranging from 20-60 L/m3.

### Example 27

A preservative treating composition comprising 2.95% Cu and 0.12% Tebuconazole is prepared by mixing a 12.86% copper concentrate and a tebuconazole solution in a hydrocarbon solvent carrier (butanol) and then diluted with D80 solvent (aromatic content of <1% and flash point >80° C.). The prepared treating fluid is used to treat radiata pine plywood measuring 12 mm×8 mm×900 mm using a low pressure process wherein the plywood is initially immersed in the treating solution, pressure of 30 kPa is applied for 2 minutes, the solution is removed and a final vacuum of −85 kPa is applied for 10 minutes. The treated plywood has a clear surface. A copper spot test shows that the treated wood meetsthe requirements of AS/NZS1604.4 with uptakes of 30-40 L/m³.

### Example 28

A preservative treating composition comprising 2.95% Cu and 0.12% Tebuconazole is prepared by mixing a 12.86% copper concentrate and a tebuconazole solution in a hydrocarbon solvent carrier (butanol) and then diluted with D40 solvent (aromatic content of <1% and flash point >40° C.). The prepared treating fluid is used to treat radiata pine plywood measuring 12 mm×8 mm×900 mm using a low pressure process wherein the plywood is initially immersed in the treating solution, pressure of 30 kPa is applied for 2 minutes, the solution is removed and a final vacuum of −85 kPa is applied for 10 minutes. The treated plywood has a clear surface. A copper spot test shows that the treated wood meets the requirements of AS/NZS1604.4 with uptakes of 60-80 L/m3.

### Example 29

A preservative treating composition comprising 2.95% Cu and 0.12% Tebuconazole is prepared by mixing a 12.86% copper concentrate and a tebuconazole solution in a hydrocarbon solvent carrier (butanol) and then diluted with white spirits solvent (aromatic content of <20%, flash point 40-42° C.). The prepared treating fluid is used to treat radiata pine samples measuring 90 mm×45 mm×900 mm using a Rueping process wherein an initial air pressure of 50 kPa is applied and held for 1 minute. Treating solution is then pumped into the treatment cylinder while the pressure is maintained and once full the pressure is increased to 110 kPa for 2 minutes. The solution is removed and a final vacuum of −85 kPa was applied for 10 minutes. The treated wood has a clear surface. A copper spot test shows that the treated wood meets the requirements of AS/NZS1604.1 with uptakes of 20-40 L/m3.

1-173. (canceled)

174. A wood preservative composition comprising:
a. an organic solvent carrier having low aromatic content;
b. a dispersion of solid particles of a metal compound having a particle size between about 0.005 microns to about 10 microns;
c. an organic biocide; and
d. a dispersant.

175. A wood preservative composition comprising:
a. a biodegradable organic solvent carrier selected from the group consisting of vegetable oil, renewable resource oil, and biodiesel;
b. a dispersion of solid particles of a metal compound having a particle size between about 0.005 microns to about 10 microns;
c. an organic biocide; and
d. a dispersant.

176. The wood preservative of claim 175, wherein said organic solvent is a vegetable oil selected from the group consisting of linseed oil, coconut oil, corn oil, cottonseed oil, olive oil, palm oil, canola oil, palm kernel oil, peanut oil, rapeseed oil, safflower oil, sesame oil, soybean oil, sunflower oil, castor oil, tung oil, poppy seed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

177. The wood preservative composition of claim 174, wherein said organic biocide is a triazole or a pyrazole.

178. The wood preservative composition of claim 177, wherein said triazole is selected from the group consisting of azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

179. The wood preservative composition of claim 177, wherein said pyrazole is selected from the group consisting of benzovindiflupyr, bixafen, fenpyrazamine, fluxapyroxad, furametpyr, isopyrazam, oxathiapiprolin, penflufen, penthiopyrad, pydiflumetofen, pyraclostrobin, pyrametostrobin, pyraoxystrobin, rabenzazole, and sedaxane.

180. A method of treating a wood product comprising contacting said wood product with a composition comprising:
a. an organic solvent carrier having low aromatic content;
b. a dispersion of solid particles of a metal compound having a particle size between about 0.005 microns to about 10 microns;
c. an organic biocide; and
d. a dispersant.

181. A method of treating a wood product comprising contacting said wood product with a composition comprising:
a. a biodegradable organic solvent carrier selected from the group consisting of vegetable oil, renewable resource oil, and biodiesel;
b. a dispersion of solid particles of a metal compound having a particle size between about 0.005 microns to about 10 microns;
c. an organic biocide; and
d. a dispersant.

182. The method of claim 181, wherein said organic solvent is a vegetable oil selected from the group consisting of linseed oil, coconut oil, corn oil, cottonseed oil, olive oil, palm oil, canola oil, palm kernel oil, peanut oil, rapeseed oil, safflower oil, sesame oil, soybean oil, sunflower oil, castor oil, tung oil, poppy seed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

183. A method of making a dispersion comprising the following steps:
a. combining an organic solvent carrier having low aromatic content, solid particles of a metal compound, and a dispersant;
b. transferring the mixture of step (a) to a grinding mill pre-filled with a grinding media; and
c. grinding the mixture of step (a) to a particle size between about 0.005 microns to about 10 microns.

184. A wood product produced by the process of treating said wood product with a wood preservative composition, wherein said wood preservative composition comprises:
a. an organic solvent carrier having low aromatic content;
b. a dispersion of solid particles of a metal compound having a size between about 0.005 microns to about 10 microns;
c. an organic biocide; and
d. a dispersant.

185. A wood preservative composition comprising:
a. an organic solvent carrier having low aromatic content; and
b. an amount of penflufen effective to render wood treated with said composition resistant to fungal decay.

186. A wood preservative composition comprising:
a. a biodegradable organic solvent carrier selected from the group consisting of vegetable oil, renewable resource oil, and biodiesel.
b. an amount of penflufen effective to render wood treated with said composition resistant to fungal decay.

187. The wood preservative of claim 186, wherein said organic solvent is a vegetable oil selected from linseed oil, coconut oil, corn oil, cottonseed oil, olive oil, palm oil, canola oil, palm kernel oil, peanut oil, rapeseed oil, safflower oil, sesame oil, soybean oil, sunflower oil, castor oil, tung oil, poppy seed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

188. A method of treating a wood product to render it resistant to fungal decay, said method comprising the steps of
a. contacting said wood with a composition comprising: (i) an organic solvent carrier having low aromatic content; and (ii) penflufen; and
b. drying said wood product, wherein the treated wood product is rendered resistant to fungal decay.

189. A method of treating a wood product to render it resistant to fungal decay, said method comprising the steps of
a. contacting said wood with a composition comprising: (i) a biodegradable organic solvent carrier selected from the group consisting of vegetable oil, renewable resource oil, and biodiesel; and (ii) an effective amount of penflufen to render said wood resistant to fungal decay; and
b. drying said wood product, wherein the treated wood product is rendered resistant to fungal decay.

190. The wood preservative of claim 189, wherein said organic solvent is a vegetable oil selected from linseed oil, coconut oil, corn oil, cottonseed oil, olive oil, palm oil, canola oil, palm kernel oil, peanut oil, rapeseed oil, safflower oil, sesame oil, soybean oil, sunflower oil, castor oil, tung oil, poppy seed oil, vernonia oil, almond oil, beech nut oil, Brazil nut oil, virgin oil, cashew oil, hazelnut oil, macadamia oil, mongongo nut oil (or manketti oil), pecan oil, pine nut oil, pistachio oil, walnut oil, pumpkin seed oil, pracaxi oil, grape seed oil, rice bran oil, carapa oil, and hempseed oil.

191. The method of claim 189, wherein said composition comprises substantially no copper compound particles.

192. A wood product treated with the composition of claim 185.

193. A wood product treated with the composition of claim 187.

194. A wood product treated by the method of claim 188.

195. A wood product treated by the method of claim 189.

196. The composition of claim 174 further comprising a termiticide.

197. The composition of claim 175 further comprising a termiticide.

198. The composition of claim 185 further comprising a termiticide.

199. The composition of claim 186 further comprising a termiticide.

200. The wood preservative composition of claim 175, wherein said organic biocide is a triazole or a pyrazole.
